(19) United States
(12) Patent Application Publication
(10) Pub. No.: US 2024/0184498 A1
(43) Pub. Date: Jun. 6, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: TOMOYA ISHIKAWA, TOKYO (JP); GAKU NARITA, TOKYO (JP); TAKASHI SENO, TOKYO (JP)

(21) Appl. No.: 18/554,321

(22) PCT Filed: Jan. 13, 2022
(86) PCT No.: PCT/JP2022/000901

§ 371 Date: Oct. 6, 2023

(30) Foreign Application Priority Data
Apr. 22, 2021 (JP) 2021-072624

(51) Int. Cl. G06F 3/14; G06F 3/0481

(52) U.S. Cl. CPC G06F 3/14; G06F 3/0481

(57) ABSTRACT

It is desired to provide a technology capable of more efficiently supporting a user's action. Provided is an information processing apparatus including: a presentation control unit that controls presentation of information regarding an action target to a first user on the basis of satisfaction of a predetermined condition; and an information acquisition unit that acquires a first action of the first user after the information regarding the action target is presented.

### TECHNICAL FIELD

The present disclosure relates to an information processing apparatus, an information processing method, and a program.

### BACKGROUND ART

In recent years, various techniques for supporting user's actions are known. For example, a technology of extracting an action executed by many users from among actions of other users executed in the past and proposing the extracted action to the user is disclosed (see, for example, Patent Document 1).

### CITATION LIST

### Patent Document

Patent Document 1: Japanese Patent Application Laid-Open No. 2009-201809

### SUMMARY OF THE INVENTION

### Problems to be Solved by the Invention

However, it is desired to provide a technology capable of more efficiently supporting the user's action.

### Solutions to Problems

According to an aspect of the present disclosure, there is provided an information processing apparatus including: a presentation control unit that controls presentation of information regarding an action target to a first user on the basis of satisfaction of a predetermined condition; and an information acquisition unit that acquires a first action of the first user after the information regarding the action target is presented.

Furthermore, according to another aspect of the present disclosure, there is provided an information processing method including: controlling presentation of information regarding an action target to a first user on the basis of satisfaction of a predetermined condition; and acquiring, by a processor, a first action of the first user after the information regarding the action target is presented.

Furthermore, according to another aspect of the present disclosure, there is provided a program for causing a computer to function as an information processing apparatus including: a presentation control unit that controls presentation of information regarding an action target to a first user on the basis of satisfaction of a predetermined condition; and an information acquisition unit that acquires a first action of the first user after the information regarding the action target is presented.

### BRIEF DESCRIPTION OF DRAWINGS

FIG. 1 is a diagram for explaining a configuration example of an information processing system according to an embodiment of the present disclosure.

FIG. 2 is a diagram illustrating a functional configuration example of an interface device.

FIG. 3 is a diagram illustrating a functional configuration example of an information processing apparatus.

FIG. 4 is a block diagram illustrating an overall flow of processing executed by the information processing system according to the embodiment of the present disclosure.

FIG. 5 is a flowchart illustrating an example of a flow of processing in action log DB construction.

FIG. 6 is a diagram illustrating an example of a detailed log recorded in a detailed action log DB.

FIG. 7 is a diagram illustrating an example of an abstraction log in a virtual world recorded in an abstraction action log DB.

FIG. 8 is a diagram illustrating an example of an abstraction log in the real world recorded in an abstraction action log DB.

FIG. 9 is a diagram illustrating an example of data recorded in a feedback DB.

FIG. 10 is a flowchart illustrating an example of a flow of processing in target candidate presentation.

FIG. 11 is a diagram illustrating an example of a target candidate presentation screen.

FIG. 12 is a flowchart illustrating an example of a flow of processing in action candidate presentation.

FIG. 13 is a diagram illustrating an example of an action candidate presentation screen.

FIG. 14 is a diagram illustrating an example of a model action example screen.

FIG. 15 is a block diagram illustrating a hardware configuration example of an information processing apparatus.

### MODE FOR CARRYING OUT THE INVENTION

A preferred embodiment of the present disclosure will now be described in detail with reference to the accompanying drawings. Note that, in the present specification and the drawings, components having substantially the same functional configurations are denoted by the same reference numerals, and redundant descriptions are omitted.

Furthermore, in the present specification and the drawings, a plurality of components having substantially the same or similar functional configurations may be distinguished by attaching different numbers after the same reference numerals. However, in a case where there is no need to specifically distinguish a plurality of components having substantially the same or similar functional configurations from each other, only the same reference numerals are added thereto. Furthermore, similar components of different embodiments may be distinguished by adding different alphabets after the same reference numerals. However, in a case where it is not necessary to particularly distinguish each of the similar components, only the same reference numeral is assigned.

Note that the description will be given in the following order.
0. Outline
1. Details of Embodiment
1.1. System Configuration Example
1.2. Functional Configuration Example
1.3. Functional Details
2. Hardware Configuration Example
3. Summary

### <0. Outline>

First, an overview of an embodiment of the present disclosure will be described. In recent years, various techniques for supporting user's actions are known. For example, Patent Document 1 described above discloses a technique of extracting an action executed by many users from among actions of other users executed in the past and proposing the extracted action to the user. However, it is desired to provide a technology capable of more efficiently supporting the user's action.

In the embodiment of the present disclosure, information regarding a target action (action target) of the user is presented to the user on the basis of satisfaction of a predetermined condition. Accordingly, since the information regarding the action target is presented to the user at a more appropriate timing, the action of the user can be more efficiently supported.

Note that, hereinafter, the predetermined condition is also referred to as a “target candidate presentation condition”. Details of the target candidate presentation condition will be described later. Furthermore, hereinafter, the user is also referred to as a “player”. Moreover, hereinafter, the user (first user) who receives the presentation of the information regarding the action target is also referred to as a “subsequent player”, and the user (second user) whose action is recorded in the action log DB (database) referred to for determining the action target is also referred to as a “preceding player”.

More specifically, for a player who operates an avatar who has visited the virtual world (virtual space) for the first time, it may be difficult to grasp how to cause the avatar to act in the site. Therefore, Patent Document 1 describes a technique for supporting a player's action by presenting to the player what action an avatar who has visited a site in the past has executed.

However, it is considered that the technique described in Patent Document 1 (hereinafter, also simply referred to as “prior art”) mainly has the following three points (1) to (3) to be improved. Note that since the avatar can correspond to a virtual self of the player existing in the virtual world, the action of the avatar in the virtual world operated by the player can correspond to the action of the player in the virtual world. As will be described later, the avatar can correspond to an example of an object (virtual object) existing in the virtual world.
(1) The fact that only the virtual world is targeted: it is conceivable that the virtual world and the real world (real space) affect each other in metaverse. Therefore, it is desired to propose an action target in consideration of not only an action in the virtual world but also an action in the real world. The technology according to the embodiment of the present disclosure handles, as an example, an action log obtained in the real world in an abstract manner. That is, the technology according to the embodiment of the present disclosure is different from the prior art in that not only the action log obtained in the virtual world but also the action log obtained in the real world can be analyzed and proposed.
(2) Force of uniform action target: It is considered that the action target of the player in the metaverse varies. Therefore, it is possible to assume a case where appropriate support for the subsequent player is not provided only by suggesting past actions executed by many preceding players as action targets to the subsequent player. In an embodiment of the present disclosure, a target candidate may be proposed to a subsequent player on the basis of past action executed by a preceding player and feedback information from the preceding player. Then, an action selected by the subsequent player from the target candidates can be proposed to the subsequent player.
(3) The lack of options for the proposed action: There are many different action styles, and uniform action support (including operation support) for the player may not be helpful. Therefore, the technology according to the embodiment of the present disclosure proposes time-series data of actions as action candidates to the subsequent player on the basis of the past actions of the preceding players and feedback information from the preceding players, and proposes an action selected from the action candidates to the subsequent player according to the preference of the subsequent player.

The above is the outline of the embodiment of the present disclosure.

### <1. Details of Embodiment>

Next, the embodiment of the present disclosure is described in detail.

### (1.1. System Configuration Example)

First, a configuration example of an information processing system according to the embodiment of the present disclosure will be described.

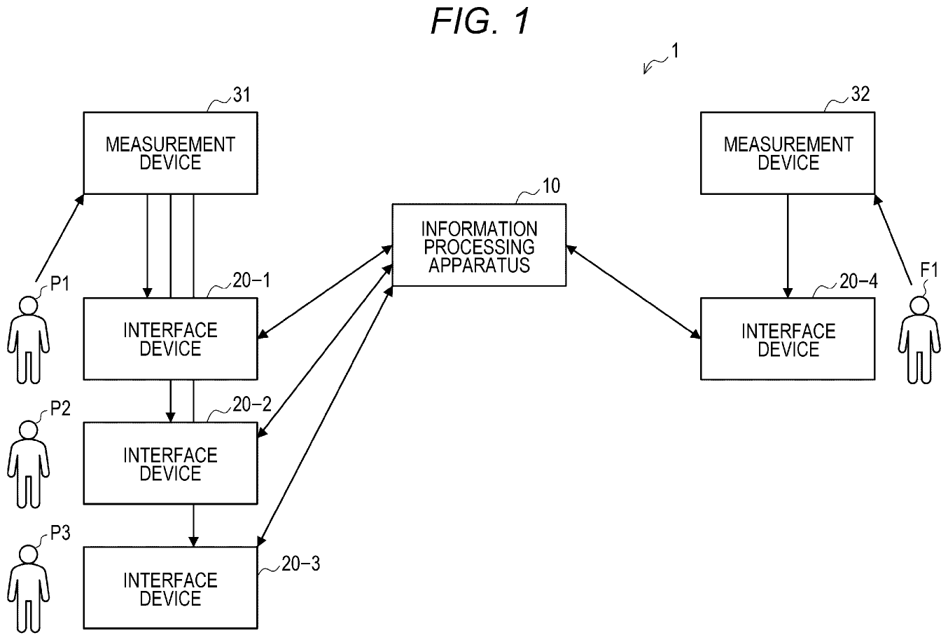

FIG. 1 is a diagram for explaining a configuration example of an information processing system according to the embodiment of the present disclosure. As illustrated in FIG. 1, an information processing system 1 according to the embodiment of the present disclosure includes an information processing apparatus 10, interface devices 20-1 to 20-4, a measurement device 31, and a measurement device 32. Hereinafter, some or all of the interface devices 20-1 to 20-4 may be referred to as interface devices 20 without being particularly distinguished.

As illustrated in FIG. 1, there is a plurality of players (for example, preceding players P1 to P3, a subsequent player F1, and the like) in the real world. In the example illustrated in FIG. 1, a case where the number of preceding players is three is mainly assumed, but the number of preceding players is not limited and may be one or plural. In addition, in the example illustrated in FIG. 1, a case where the number of subsequent players is one is mainly assumed, but the number of subsequent players is not limited and may be plural. An example of determination that the player corresponds to the preceding player and an example of determination that the player corresponds to the subsequent player will be described later.

### (Measurement Device 31)

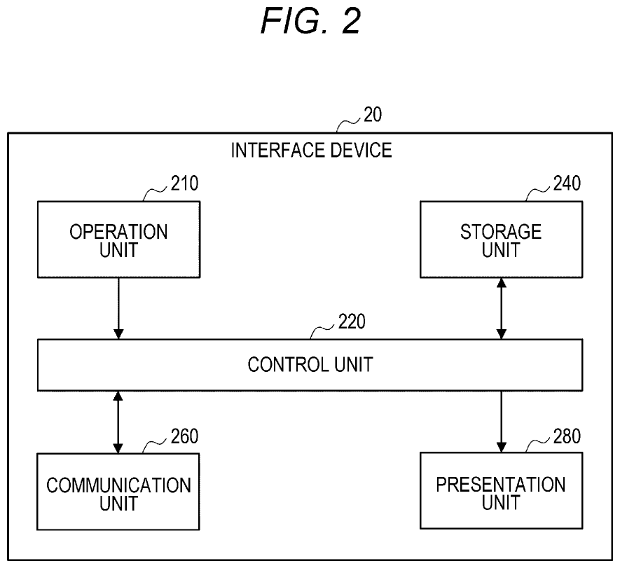

The measurement device 31 performs predetermined measurement related to the preceding players P1 to P3. As an example, the measurement device 31 measures three-dimensional coordinates, three-dimensional postures, and the like of the preceding players P1 to P3 in the real world. Note that, in the embodiment of the present disclosure, a case where the measurement device 31 is an environmental installation type measurement device is mainly assumed. As the environmental installation type measurement device, a predetermined image sensor (for example, a monitoring camera or the like) or the like can be used. However, the measurement device 31 may be incorporated in the operation unit 210 (FIG. 2) of the interface devices 20-1 to 20-3.

In the example illustrated in FIG. 1, a case where the measurement related to the preceding players P1 to P3 is collectively performed by one measurement device 31 is assumed. However, the measurement related to the preceding players P1 to P3 may be performed in a distributed manner by a plurality of measurement devices 31.

### (Measurement Device 32)

The measurement device 32 performs predetermined measurement related to the subsequent player F1. As an example, the measurement device 32 measures the three-dimensional coordinates, the three-dimensional posture, and the like of the subsequent player F1 in the real world. Note that, in the embodiment of the present disclosure, a case where the measurement device 32 is an environmental installation type measurement device is mainly assumed. As the environmental installation type measurement device, a predetermined image sensor (for example, a monitoring camera or the like) or the like can be used. However, the measurement device 32 may be incorporated in the operation unit 210 (FIG. 2) of the interface device 20-4.

### (Interface Device 20)

The interface device 20 is used by a corresponding player. More specifically, the interface device 20-1 is used by the preceding player P1, the interface device 20-2 is used by the preceding player P2, the interface device 20-3 is used by the preceding player P3, and the interface device 20-4 is used by the subsequent player F1.

In the embodiment of the present disclosure, a case where the interface device 20 is an augmented reality (AR) device (for example, AR glasses) worn on a player's body is mainly assumed. However, the interface device 20 is not limited to the AR device. For example, the interface device 20 may be a wearable device (for example, a virtual reality (VR) device or the like) other than the AR device.

Alternatively, the interface device 20 may be a device other than a wearable device (for example, a smartphone, a smart watch, a game machine, a personal computer (PC), or the like).

The interface device 20 can access the virtual world constructed by the information processing apparatus 10 via a network (not illustrated). In the virtual world, there is an avatar corresponding to the player, and the player can operate the avatar by an input to the interface device 20. As described above, the avatar can correspond to an example of a virtual object existing in the virtual world.

FIG. 2 is a diagram illustrating a functional configuration example of the interface device 20. As illustrated in FIG. 2, the interface device 20 includes an operation unit 210, a control unit 220, a storage unit 240, a communication unit 260, and a presentation unit 280.

### (Operation Unit 210)

The operation unit 210 has a function of receiving an operation input by a player. For example, the operation unit 210 may include an input device such as a mouse, a keyboard, a touch panel, a button, a microphone, a game controller, or the like. For example, the operation unit 210 receives an operation input by a player as a determination operation. In addition, processing according to the posture of the interface device 20 may be executed by the determination operation received by the operation unit 210.

### (Control Unit 220)

The control unit 220 may be formed with one or a plurality of central processing units (CPUs; arithmetic processing devices) or the like, for example. In a case where the control unit 220 is formed with a processing device such as a CPU, the processing device may be formed with an electronic circuit. The control unit 220 can be formed by the processing device executing a program.

### (Storage Unit 240)

The storage unit 240 is a recording medium that includes a memory, and stores a program to be executed by the control unit 220 and the data necessary for executing the program. Also, the storage unit 240 temporarily stores data for calculation to be performed by the control unit 220. The storage unit 240 is formed with a magnetic storage device, a semiconductor storage device, an optical storage device, a magneto-optical storage device, or the like.

### (Communication Unit 260)

The communication unit 260 includes a communication interface. For example, the communication unit 260 communicates with the information processing apparatus 10 via a network (not illustrated) or communicates with the measurement device 31 via a network (not illustrated).

### (Presentation Unit 280)

The presentation unit 280 presents various types of information to the player under the control of the control unit 220. For example, the presentation unit 280 may include a display. At this time, the display may be a transmissive display capable of visually recognizing a real-world image, an optical see-through display, or a video see-through display. Alternatively, the display may be a non-transmissive display that presents a virtual world image having a three-dimensional structure corresponding to the real world instead of the real-world image.

The transmissive display is mainly used for augmented reality (AR), and the non-transmissive display is mainly used for virtual reality (VR). Furthermore, the presentation unit 280 may also include an X Reality (XR) display used for both AR and VR. For example, the presentation unit 280 performs AR display or VR display of the virtual object, or UI display of text or the like.

Note that the presentation of various types of information by the presentation unit 280 may be performed by voice presentation by a speaker, may be performed by haptic presentation by a haptic presentation apparatus, or may be performed by another presentation device.

Returning to FIG. 1, the description of the information processing apparatus 10 will be continued.

### (Information Processing Apparatus 10)

The information processing apparatus 10 can be realized by a computer. The information processing apparatus 10 is connected to a network (not illustrated), and can communicate with the interface devices 20-1 to 20-4 via the network (not illustrated). The information processing apparatus 10 constructs a virtual world in which a plurality of players (for example, the preceding players P1 to P3, the subsequent player F1, and the like) existing in the real world can participate.

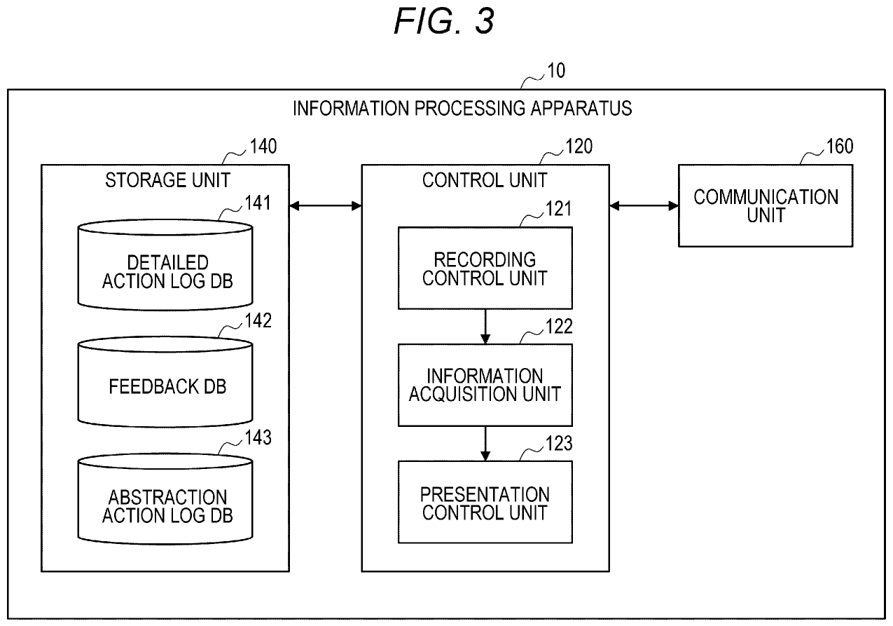

FIG. 3 is a diagram illustrating a functional configuration example of the information processing apparatus 10. As illustrated in FIG. 3, the information processing apparatus 10 includes a control unit 120, a storage unit 140, and a communication unit 160.

### (Control Unit 120)

The control unit 120 may be formed with one or a plurality of central processing units (CPUs; arithmetic processing devices or the like), for example. In a case where the control unit 120 is formed with a processing device such as a CPU, the processing device may be formed with an electronic circuit. The control unit 120 can be formed by the processing device executing a program. The control unit 120 includes a recording control unit 121, an information acquisition unit 122, and a presentation control unit 123. Specific functions of these blocks will be described in detail later.

### (Storage Unit 140)

The storage unit 140 is a recording medium that includes a memory, and stores a program to be executed by the control unit 120 and the data (various databases and the like) necessary for executing the program. The storage unit 140 stores a detailed action log DB 141, a feedback DB 142, and an abstraction action log DB 143 as examples of the database. Each of the detailed action log DB 141 and the abstraction action log DB 143 is an example of the action log DB. These databases will be described in detail later.

Also, the storage unit 140 temporarily stores data for calculation to be performed by the control unit 120. The storage unit 140 includes a magnetic storage unit device, a semiconductor storage device, an optical storage device, a magneto-optical storage device, or the like.

### (Communication Unit 160)

The communication unit 160 includes a communication interface. For example, the communication unit 160 communicates with the interface devices 20-1 to 20-4 via a network (not illustrated).

The configuration example of the information processing system 1 according to the embodiment of the present disclosure has been described above.

### (1.2. Functional Details)

Next, functional details of the information processing system 1 according to the embodiment of the present disclosure will be described.

An object of a technology according to the embodiment of the present disclosure is to support improvement in efficiency of achievement of a goal by a subsequent player by using an action log of a preceding player who has experienced a world in which the metaverse is realized.

The metaverse refers to a world that is not a world closed to a specific virtual world like a consumer video game, but has high data compatibility between the virtual world and the real world or between different virtual worlds, and not only a game developer but also a player can contribute to the construction of the world and freely conduct economic activities.

In such a metaverse, it can be said that it is difficult to create action support in a specific situation like a tutorial in a general application (for example, a game application or the like).

More specifically, in a general game application or the like, since it is not assumed that a situation not intended by the developer occurs, it is possible for the developer to create in advance what kind of action support is to be provided to the player in the assumed situation.

On the other hand, in the metaverse, the virtual world continues to change from moment to moment due to the influence from not only the developer but also the real world (player or the like). Therefore, it is difficult to create action support for the player in advance. In addition, since the degree of freedom of action is high in the metaverse, there are various ways of enjoyment by the player, how the player experiences the world, and the like. For this reason, there may be a case where the subsequent player cannot grasp what is the target to perform the action in the metaverse and becomes confused.

Therefore, the technology according to the embodiment of the present disclosure improves the action support for the subsequent player in the metaverse as described above, thereby setting a target that the subsequent player desires to aim at and enabling the action support for efficiently achieving the target. The technology according to the embodiment of the present disclosure realizes such action support mainly by processing in the following Step 1 to 3 (3 steps).

### Step 1. Action Log DB Construction

This step may correspond to processing of recording the action of the preceding player as an abstract action log and associating the action log with the feedback information.

### Step 2. Target Candidate Presentation

This step may correspond to processing of generating a target candidate for the subsequent player on the basis of the action log DB and the feedback information constructed in Step 1 and presenting information regarding the target candidate according to the situation of the subsequent player.

### Step 3. Action Candidate Presentation

This step may correspond to processing of generating an action candidate for realizing the target selected in Step 2 and presenting information regarding the action candidate according to the situation of the subsequent player.

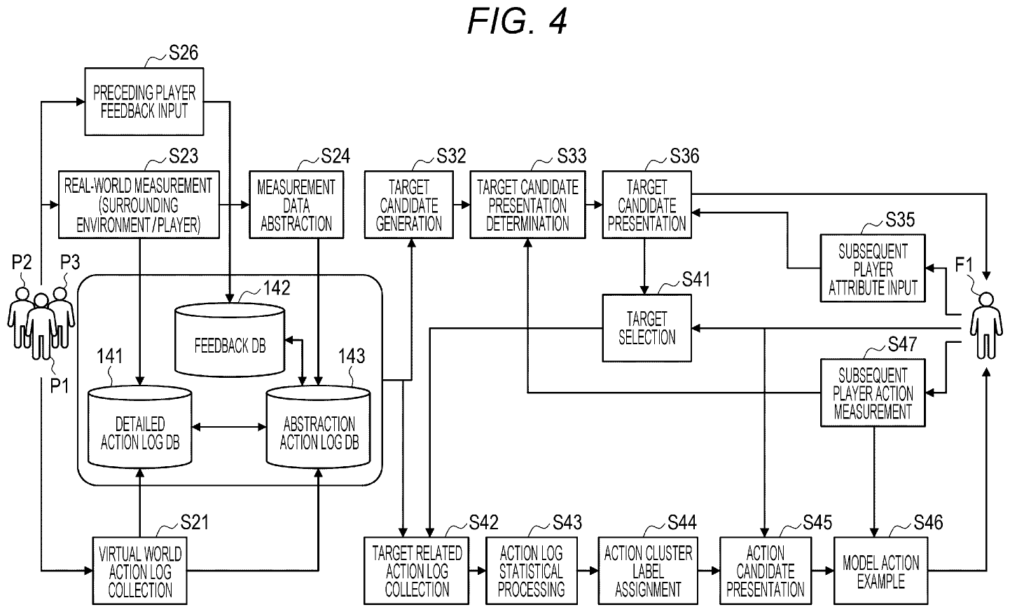

FIG. 4 is a block diagram illustrating an overall flow of processing executed by the information processing system 1 according to the embodiment of the present disclosure. Hereinafter, details of each of Step 1 to 3 described above will be described with reference to FIG. 4 (with reference to other drawings as appropriate).

### (Step 1. Action Log DB Construction)

In this step, the action log of the preceding player and the feedback information are accumulated in the database. The action log and the feedback information accumulated in the database are used for target candidate generation and action candidate generation to be described later. In particular, in the metaverse in which the virtual world and the real world are strongly associated with each other, it is desirable that the action logs of both the worlds are handled without distinction. Therefore, it is desirable that the action log be accumulated not only at a detailed level such as the three-dimensional coordinates and the three-dimensional posture of the preceding player but also at an abstract level such as “the player A has performed C on the object B”.

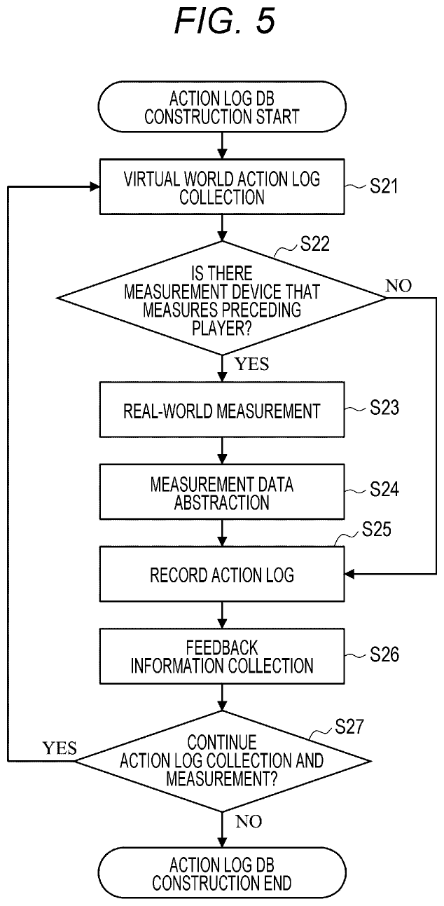

FIG. 5 is a flowchart illustrating an example of a flow of processing in the action log DB construction corresponding to Step 1 described above.

### (S21. Virtual World Action Log Collection)

As illustrated in FIGS. 4 and 5, the recording control unit 121 continuously collects action logs of preceding players in the virtual world in a time series (S21). Then, the recording control unit 121 records the collected action logs in the virtual world in the action log DB. Note that, as an example, the recording control unit 121 may determine a player performing an action different from a target candidate to be described later as a preceding player. This makes it possible to increase variations of the action log recorded in the action log DB.

Here, a case where two types of detailed logs and abstraction logs are collected is mainly assumed as an example of the action log of the preceding player in the virtual world collected by the recording control unit 121. The recording control unit 121 records the collected detailed log in the virtual world in the detailed action log DB 141, and records the collected abstraction log in the virtual world in the abstraction action log DB 143. The detailed log and the abstraction log will be described in more detail.

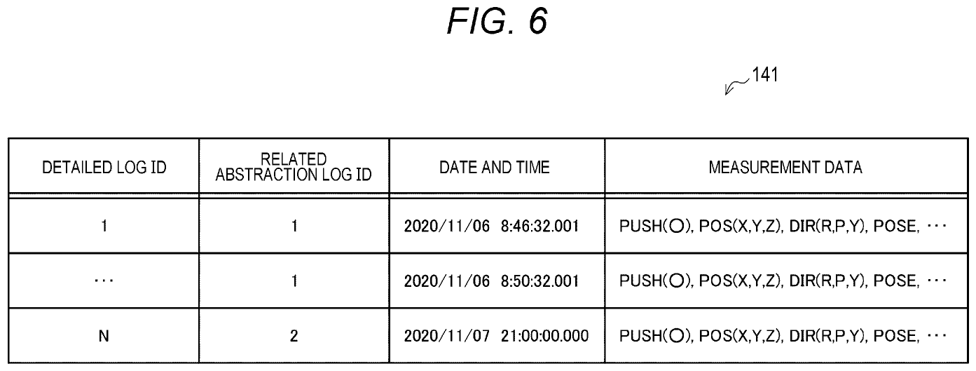

FIG. 6 is a diagram illustrating an example of a detailed log recorded in the detailed action log DB 141. As illustrated in FIG. 6, the detailed log includes a “detailed log ID” which is an ID for identifying the detailed log, a “related abstraction log ID” which is an ID for identifying an abstraction log related to the detailed log, a “date and time” when the detailed log is collected, and “measurement data” indicating contents of the detailed log.

As illustrated in FIG. 6, the “measurement data” may correspond to detailed data of the player's action in the virtual world, such as a button pressed by the player (PUSH), three-dimensional coordinates of the avatar in the virtual world (POS), a three-dimensional orientation (DIR), a three-dimensional posture (POSE), and the like.

The past action of the preceding player in the virtual world can be reproduced by using the detailed log. However, the measurement data does not include semantic information such as what action has caused the measurement data. The meaning of the action is associated with the detailed log by the abstraction log.

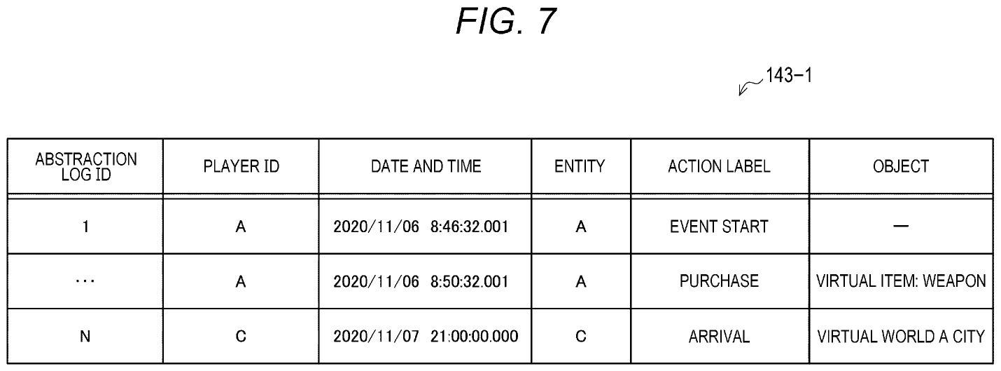

FIG. 7 is a diagram illustrating an example of an abstraction log in the virtual world recorded in the abstraction action log DB 143. As illustrated in FIG. 7, the abstraction log 143-1 includes an “abstraction log ID” that is an ID for identifying an abstraction log in the virtual world, a “player ID” that is an ID for identifying a player, a “date and time” when the abstraction log is collected, an “entity” of an action, an “action label” indicating an action of the player, and an “object” of the action.

The “entity” is mainly a player. Furthermore, the “player ID” may include an ID for identifying an avatar. The “action label” may include a relationship label indicating a relationship between an object and an entity.

In the virtual world, an occurrence timing of an event, an abstract action in the event, and the like are defined in advance. Therefore, the recording control unit 121 collects an abstract action on the basis of these pieces of information defined in advance, and records the abstract action as an abstraction log in the abstraction action log DB 143. Further, the recording control unit 121 records the detailed log including the three-dimensional coordinates, the three-dimensional posture, and the like of the avatar while the action is executed as the measurement data in the detailed action log DB 141, thereby associating the abstraction log with the detailed log.

As illustrated in FIG. 5, in a case where there is no measurement device 31 that performs measurement on the preceding player (“NO” in S22), the operation proceeds to S25.

### (S23. Real-World Measurement)

Unlike the action log in the virtual world, the action log in the real world is obtained by measuring a player in the real world by the measurement device 31. Therefore, in a case where there is the measurement device 31 that performs measurement on the preceding player (“YES” in S22), the recording control unit 121 continuously collects data (measurement data) measured by the measurement device 31 on the preceding player in the real world in a time series (S23).

Here, as described above, an environmental installation type measurement device can be used as the measurement device 31. However, the measurement device 31 may be incorporated in the operation unit 210. The recording control unit 121 continuously collects the detailed log of the preceding player in the real world in a time series on the basis of the measurement data collected in this manner.

For example, the detailed log in the real world may include measurement data such as three-dimensional coordinates, three-dimensional postures, and the like of preceding players in the real world. At this time, the three-dimensional coordinates of the preceding player may be acquired by a global positioning system (GPS) function mounted on the interface device 20 (for example, a smartphone or the like) or may be acquired by a visual simultaneous localization and mapping (SLAM) function. Furthermore, the three-dimensional posture of the preceding player may be acquired by an environmental installation type camera or the like.

In addition, the detailed log in the real world may include, as an example of measurement data, voice, vital signs, surrounding environment data obtained from a camera mounted on the interface device 20 (for example, a head-mounted display or the like), or the like. These pieces of measurement data included in the detailed log are targets of abstraction of the measurement data to be described later.

### (S24. Measurement Data Abstraction)

As illustrated in FIGS. 4 and 5, the recording control unit 121 generates an abstraction log in the real world on the basis of abstracting the measurement data included in the detailed log in the real world (S24). The abstraction log in the real world may be generated in any way.

As an example, the recording control unit 121 obtains an abstraction log by detecting an entity of an action, an object of the action, and a relationship between the entity and the object on the basis of the player and an object (including a person) existing around the player recognized from measurement data included in the detailed log in the real world. For detection of such a relationship between objects, a method based on machine learning, a method using a three-dimensional positional relationship between objects, or the like can be adopted.

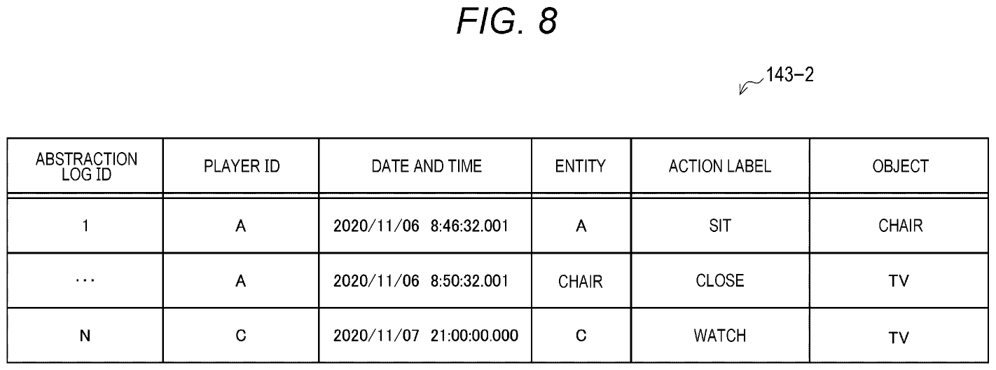

FIG. 8 is a diagram illustrating an example of an abstraction log in the real world recorded in the abstraction action log DB 143. As illustrated in FIG. 8, the abstraction log 143-2 includes an “abstraction log ID” that is an ID for identifying an abstraction log in the real world, a “player ID” that is an ID for identifying a player, a “date and time” when the abstraction log is collected, an “entity” of an action, an “action label” indicating an action of the player, and an “object” of the action.

The “entity” is mainly a player. The “action label” may include a relationship label indicating a relationship between an object and an entity.

According to the detection of the relationship between the objects, the recording control unit 121 can acquire the abstraction log in the real world illustrated in FIG. 8 as an example. Such an abstraction log in the real world can be handled in a unified manner with an abstraction log in the virtual world. In this way, the action logs of the virtual world and the real world can be handled in a unified manner, and thus, more efficient action support for the subsequent player becomes possible in the metaverse having high relevance between the virtual world and the real world.

For example, it is assumed that an action for a goal that a player wants to win a soccer game in a metaverse is supported. In such a case, even if only the action log in the virtual world is analyzed, it may be possible to only propose an action such as playing and practicing a soccer game many times.

On the other hand, by adding an action log in the real world as an analysis target, it may be found that the experience of soccer in the real world is greatly involved in the performance of the soccer game in the virtual world, that action such as information collection in the real world regarding the soccer game is greatly involved, and the like.

In fact, since there is a high possibility that actions in the real world are involved with actions and results of actions in the virtual world, it can be said that the technology according to the embodiment of the present disclosure is excellent in that actions in the real world can also be analyzed.

Then, the recording control unit 121 records the collected action log in the action log DB (S25). More specifically, the recording control unit 121 records the collected detailed log in each of the virtual world and the real world in the detailed action log DB 141. Further, the recording control unit 121 records the collected abstraction log in each of the virtual world and the real world in the abstraction action log DB 143.

In this way, the action logs in the virtual world and the real world, respectively, are continuously collected along a time series and continue to be recorded in the action log DB without distinction.

### (S26. Feedback Information Collection)

As illustrated in FIGS. 4 and 5, the recording control unit 121 also collects feedback information on the action of the preceding player in parallel with the collection of the action log of the preceding player (S26). The feedback information may be information input from the preceding player as feedback for the action of the preceding player. Then, the recording control unit 121 records the feedback information for the action in the feedback DB 142 in association with the action.

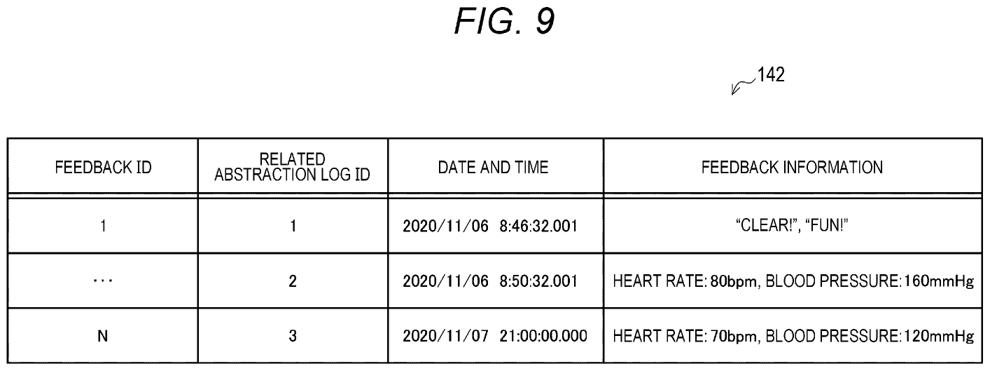

FIG. 9 is a diagram illustrating an example of data recorded in the feedback DB 142. As illustrated in FIG. 9, the data recorded in the feedback DB 142 includes a “feedback ID” which is an ID for identifying the feedback information, a “related abstraction log ID” which is an ID for identifying an abstraction log related to the feedback information, a “date and time” when the feedback information is collected, and the “feedback information”.

The feedback information may be any information as long as the information indicates feedback for the action. For example, the feedback information may include explicit feedback information such as a comment written by a preceding player. The comment writing destination may be a social networking service (SNS), a chat, or the like. Alternatively, the feedback information may include implicit feedback information, such as vital signs (for example, heart rate, blood pressure, and the like).

The feedback information can be used to generate a target candidate to be described later. As illustrated in FIG. 5, in a case where the collection and measurement of the action log are continued (“YES” in S27), the operation proceeds to S21. On the other hand, in a case where the collection and measurement of the action log are not continued (“NO” in S27), the construction of the action log DB ends.

### (Step 2. Target Candidate Presentation)

In this step, the presentation control unit 123 generates information regarding the target candidate to be presented to the subsequent player on the basis of the action log of the preceding player collected in Step 1 and the feedback information from the preceding player for the action. Note that an example of the determination that the player corresponds to the subsequent player will be described later.

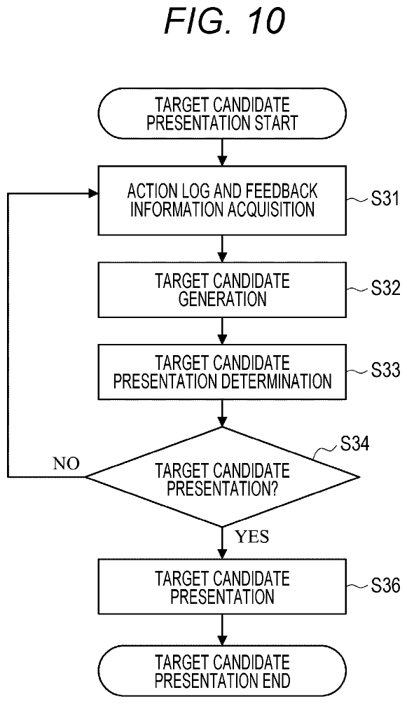

FIG. 10 is a flowchart illustrating an example of a flow of processing in the target candidate presentation corresponding to Step 2 described above. As illustrated in FIG. 10, the information acquisition unit 122 acquires the action log of the preceding player and the feedback information on the action from the preceding player (S31). More specifically, the information acquisition unit 122 acquires a detailed log from the detailed action log DB 141, acquires an abstraction log from the abstraction action log DB 143, and acquires information (including feedback information) from the feedback DB 142.

### (S32. Target Candidate Generation)

As illustrated in FIGS. 4 and 10, the presentation control unit 123 determines a target candidate to be presented to the subsequent player on the basis of the action log of the preceding player and the feedback information (S32). As a result, even in the metaverse that continues to change, the target candidate following the change in the metaverse can be set.

Here, the target candidate may be determined in any manner. As an example, the presentation control unit 123 may extract feedback information in which a predetermined index (hereinafter, also referred to as an “index of saliency”) is equal to or more than a predetermined number as feedback information with high saliency, and determine an action associated with the feedback information with high saliency as a target candidate.

At this time, the feedback information with high saliency may be extracted on the basis of the feedback information obtained from each preceding player. Alternatively, the feedback information with high saliency may be extracted on the basis of statistical data (for example, a total value, an average value, and the like) of the feedback information obtained from a plurality of preceding players.

Specifically, the index of saliency may be any index. As an example, the index of saliency may include a heart rate of a preceding player. Alternatively, the index of saliency may include the number of comments written by the preceding players. Alternatively, the index of saliency may include a predetermined number of words in a comment written by a preceding player. Note that the index of saliency may typically include a positive index, but may also include a negative index.

More specifically, since a case is typically assumed where the subsequent player is a new player, it is considered desirable that the predetermined word be a positive word (for example, information regarding a method for easily solving a problem, and the like) preferred by the new player. However, a case where the subsequent player is a skilled player can also be assumed. Therefore, the predetermined word may be a negative word (for example, information regarding a problem with a high difficulty level, information regarding a game with a high difficulty level, and the like) preferred by a skilled player.

### (S33. Target Candidate Presentation Determination)

As illustrated in FIGS. 4 and 10, the presentation control unit 123 determines whether or not to present a target candidate (S33). More specifically, the presentation control unit 123 determines whether or not to present the target candidate depending on whether or not the target candidate presentation condition is satisfied. For example, the presentation control unit 123 determines that a player who satisfies the target candidate presentation condition is a subsequent player. As will be described later, the subsequent player is a player to which information regarding the target candidate is presented.

As an example of the target candidate presentation condition, various conditions can be assumed. For example, at least one of the following presentation conditions 1 to 3 of the target candidate can be applied as the target candidate presentation condition.

(1) Target Candidate Presentation Condition 1: A Case where there is a Presentation Instruction from the Player

The target candidate presentation condition may include a condition that an instruction to present information regarding the action target is input from the player to the operation unit 210. The target candidate presentation condition 1 can be used by the player in a case where the player actively wants to receive the presentation of the information regarding the target candidate.

(2) Target Candidate Presentation Condition 2: A Case where it is Determined that the Player is Confused

The target candidate presentation condition may include a condition that the player is confused. A case is assumed where the information acquisition unit 122 acquires a player's action (second action) before the information regarding the target candidate is presented to the player (S47). In such a case, as an example, the condition that the player is confused may be a condition that the action of the player is different from the predetermined action according to the statistical data of one or a plurality of actions (indicated by the action label) recorded in the abstraction action log DB 143.

Note that the action of the player for which it is determined whether or not the player is confused may be acquired similarly to the action of the preceding player. That is, the player's action in the real world can be acquired on the basis of abstracting the measurement data obtained by the measurement by the measurement device 32. As the action of the player in the virtual world, an action of an avatar operated by the player in the virtual world can be acquired.

Here, the statistical data may be a frequency of one or a plurality of actions recorded in the abstraction action log DB 143 for each action executed by one or a plurality of preceding players. Then, the predetermined action may be an action (for example, an action within a predetermined order from a higher frequency, an action with a frequency higher than a threshold, or the like) selected according to a frequency from one or a plurality of actions recorded in the abstraction action log DB 143.

Note that, as described above, action logs of one or a plurality of preceding players in the real world can be recorded in the abstraction action log DB 143. Furthermore, an action log of an avatar operated by a preceding player can be recorded in the abstraction action log DB 143. That is, at least one of the action log of the preceding player in the real world or the action log of the preceding player in the virtual world is recorded in the abstraction action log DB 143, and these action logs are used to determine whether the player is confused.

As another example, the condition that the player is confused may include a condition that the information emitted from the player is predetermined information set in advance. For example, the information uttered by the player may be voice information, and the predetermined information may be voice information indicating confusion (for example, “What?”, “Where should I go?”, or the like). Note that the voice information is detected by the microphone included in the operation unit 210 and acquired by the information acquisition unit 122.

(2) Target Candidate Presentation Condition 3: A Case where the Feedback Information Increases

The target candidate presentation condition may include a condition that the index of saliency of the feedback information obtained from one or a plurality of preceding players corresponding to the target candidate has rapidly increased. This is because a target candidate satisfying such a condition is considered to have a value to be presented. The condition of the rapid increase may be a condition that the index of saliency of the feedback information obtained within a predetermined time is a predetermined number or more.

### (S36. Target Candidate Presentation)

As illustrated in FIG. 10, in a case where the presentation control unit 123 determines not to present the target candidate (“NO” in S34), the operation proceeds to S31. On the other hand, in a case where it is determined that the target candidate is to be presented (“YES” in S34), the presentation control unit 123 controls the presentation of the information regarding the target candidate to the subsequent player on the basis of the determination that the target candidate is to be presented (S36).

Note that the presentation control of the information regarding the target candidate can be realized by controlling the communication unit 160 so that the information regarding the target candidate is transmitted to the interface device 20 of the subsequent player. In the interface device 20 of the subsequent player, the information regarding the target candidate is received by the communication unit 260, and the information regarding the target candidate is presented to the subsequent player by the presentation unit 280.

The target candidate may be uniformly determined without depending on the subsequent player who receives the presentation of the information regarding the target candidate, or may be determined depending on the subsequent player. As an example, the target candidate may be determined on the basis of attribute information (for example, age, sex, liking/preference, and the like) of the subsequent player (filtering may be performed on the target candidate). That is, in a case where the attribute information is input from the subsequent player (S35), the presentation control unit 123 may determine the target candidate from one or a plurality of actions included in the action log of the preceding player on the basis of the attribute information of the subsequent player. Note that the liking/preference may include a desire to present only the target candidate in the real world, a desire to present only the target candidate in the virtual world, and the like.

A case is assumed where attribute information is associated with each of one or a plurality of actions included in the action log of the preceding player. In such a case, the presentation control unit 123 may determine an action associated with attribute information that matches or is similar to the attribute information of the subsequent player among the one or the plurality of actions as the target candidate. Alternatively, the presentation control unit 123 may determine, as the target candidate, an action associated with attribute information having a close similarity to the attribute information of the subsequent player among the one or the plurality of actions with priority.

The information regarding the target candidate presented to the subsequent player may be generated in any manner. For example, the information regarding the target candidate may include information obtained from one or a plurality of preceding players who has achieved the target candidate. Such information may include a screenshot illustrating the preceding player when the target candidate is achieved, may include feedback information obtained from the preceding player when the target candidate is achieved, or may include saliency information (for example, evaluation such as “good” or “bad”) obtained from the preceding player when the target candidate is achieved.

The method of generating the information regarding the target candidate is a method suitable for a case where there is a comment actively input by the preceding player or the like.

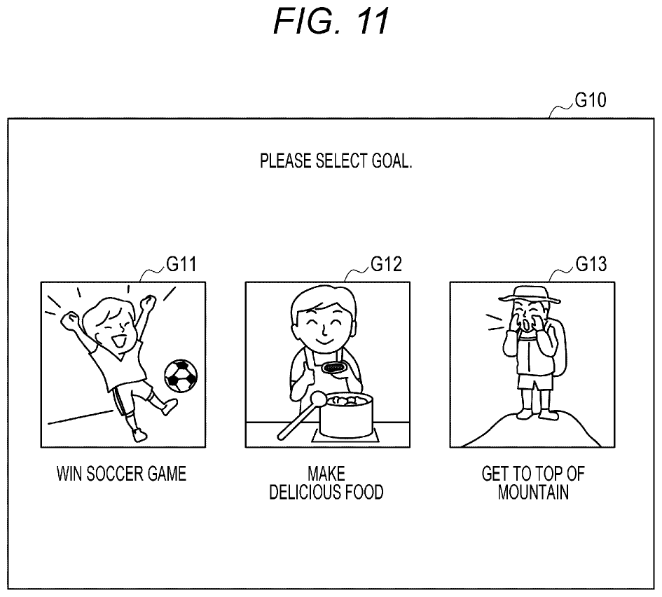

FIG. 11 is a diagram illustrating an example of a target candidate presentation screen. Referring to FIG. 11, a target candidate presentation screen G10 is illustrated. As an example, the presentation control unit 123 controls the presentation of the target candidate presentation screen G10 to the subsequent player. Note that, in the example illustrated in FIG. 11, the screenshots G11 to G13 corresponding to the three target candidates and the comments “win a soccer game”, “make delicious food”, and “get to the top of the mountain” are included in the target candidate presentation screen G10.

Furthermore, the information regarding the target candidate may include information generated on the basis of an action log regarding achievement of the target candidate of the preceding player. Such information may include a scene when the target candidate generated from the action log of the preceding player is achieved. For example, the scene may be generated by computer graphics (CG) on the basis of surrounding environment data included in the detailed log of the preceding player, a positional relationship between objects included in the abstraction log of the preceding player, and the like. Furthermore, such information may include a situation explanatory sentence such as “A did C on B” generated from the abstraction log of the preceding player, or may include information regarding saliency obtained from the preceding player when the target candidate is achieved.

The method of generating the information regarding the target candidate is a method suitable for a case where the location where the preceding player has achieved the target candidate is a location that other players cannot enter in the real world, a private space, or the like. In this way, even if the location where the target candidate is achieved is a location in the real world that is physically unreachable by the subsequent player, the target candidate can be presented such that the subsequent player can achieve the same quality of experience as the experience of the preceding player by utilizing the abstraction log.

### (Step 3. Action Candidate Presentation)

In this step, the presentation control unit 123 controls the presentation of the information regarding the action candidate to the subsequent player on the basis of the selection of one of the target candidates by the subsequent player. Furthermore, in this step, the presentation control unit 123 controls the presentation of the information regarding the model action to the subsequent player on the basis of the selection of any action candidate by the subsequent player.

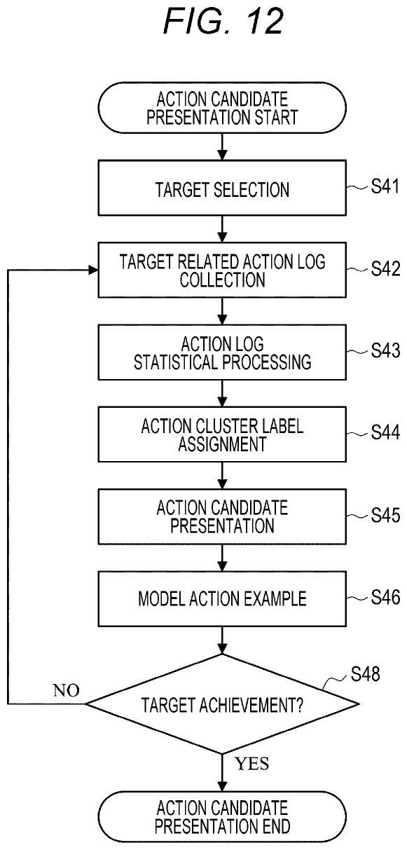

FIG. 12 is a flowchart illustrating an example of a flow of processing in the action candidate presentation corresponding to Step 3 described above. As illustrated in FIGS. 4 and 12, the subsequent player selects one of one or a plurality of target candidates (S41).

### (S42. Target Related Action Log Collection)

As illustrated in FIGS. 4 and 12, the information acquisition unit 122 acquires the action log of the preceding player who has achieved the target candidate selected by the subsequent player and the feedback information on the action from the preceding player (S42). More specifically, the information acquisition unit 122 acquires a detailed log from the detailed action log DB 141, acquires an abstraction log from the abstraction action log DB 143, and acquires information (including feedback information) from the feedback DB 142.

### (S43. Action Log Statistical Processing)

The presentation control unit 123 acquires, as an action sequence, time-series data of a plurality of actions leading to achievement of the target candidate by the preceding player on the basis of an action log of the preceding player who has achieved the target candidate selected by the subsequent player. For example, the action sequence leading to the achievement of the target candidate may be an action executed subsequently until the target candidate is reached among one or a plurality of actions of the preceding player included in the abstraction log.

As illustrated in FIGS. 4 and 12, the presentation control unit 123 determines an action candidate by performing statistical processing on a plurality of action sequences (S43). More specifically, the presentation control unit 123 maps the plurality of action sequences and the feedback information corresponding to the action sequences on a feature space (multidimensional feature space) having a predetermined parameter as an axis for each action sequence. Then, the presentation control unit 123 performs clustering on a plurality of action sequences mapped to the feature space.

Here, the predetermined parameter may include at least one of the time required to achieve the goal, the operation difficulty level, the number of opponents, or the enjoyment. Note that the time required to achieve the goal can be calculated from the average time to achieve the goal of the preceding players. The operation difficulty level, the number of opponents, and the like can be obtained from the application. Furthermore, the enjoyment can be acquired from feedback information of a preceding player or the like.

### (S44. Action Cluster Label Assignment)

As illustrated in FIGS. 4 and 12, the presentation control unit 123 labels each of a plurality of clusters generated by clustering (S44). As the label attached to the cluster, a parameter that is noticeable for the cluster may be used. For example, a cluster having the shortest time required to achieve the goal may be labeled with a “shortest goal achievement course” corresponding to the parameter “time required to achieve the goal”.

### (S45. Action Candidate Presentation)

As illustrated in FIGS. 4 and 12, the presentation control unit 123 controls presentation of information regarding an action candidate according to a plurality of action sequences of one or a plurality of preceding players who has achieved the target candidate to the subsequent player. For example, the information regarding the action candidate may include the label assigned to the cluster as described above. Furthermore, similarly to the information regarding the target candidate, the information regarding the action candidate may include information obtained from one or a plurality of preceding players who has achieved the target candidate, or may include information generated on the basis of an action log regarding achievement of the target candidate of the preceding player.

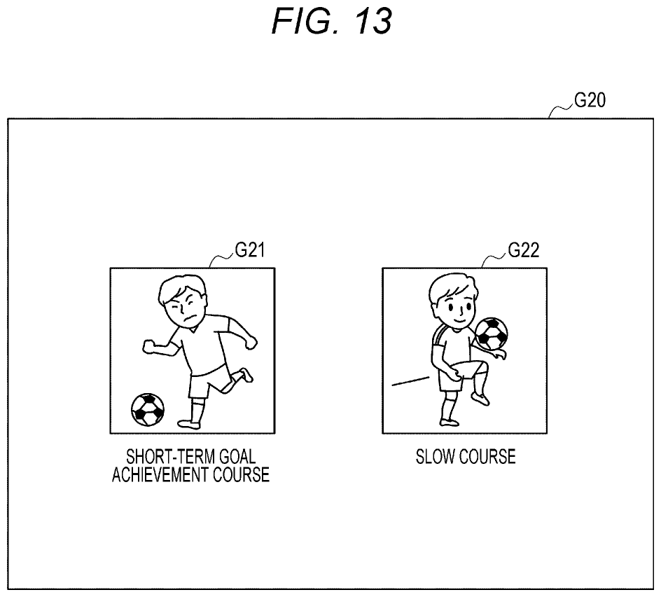

FIG. 13 is a diagram illustrating an example of the action candidate presentation screen. Referring to FIG. 13, an action candidate presentation screen G20 is illustrated. As an example, the presentation control unit 123 controls the presentation of the action candidate presentation screen G20 to the subsequent player. Note that, in the example illustrated in FIG. 13, screenshots G21 to G22 corresponding to two clusters (action candidates) and information “short-term goal achievement course” and “slow course” regarding labels are included in the action candidate presentation screen G20.

### (S46. Model Action Example)

Then, one of the action candidates is selected by the subsequent player. Here, the action candidate is time-series data of a plurality of actions. Therefore, in a case where an action candidate is selected by the subsequent player, the presentation control unit 123 acquires an action corresponding to the current action of the subsequent player among the selected action candidates as a model action. Then, the presentation control unit 123 controls the presentation of the information regarding the model action to the subsequent player. Accordingly, smooth achievement of the goal by the subsequent player can be supported. The presentation control unit 123 changes the model action according to the change in the action of the subsequent player.

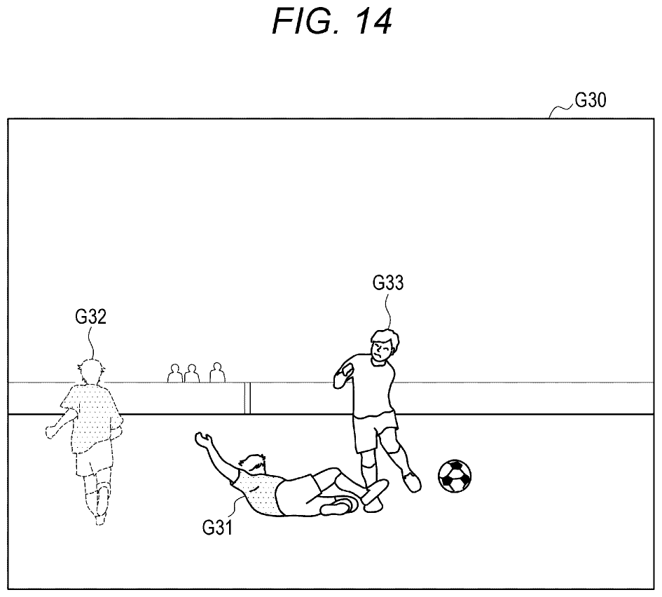

FIG. 14 is a diagram illustrating an example of a model action example screen. Referring to FIG. 14, a model action example screen G30 is illustrated. As an example, the presentation control unit 123 controls the presentation of the model action example screen G30 to the subsequent player. Note that, in the example illustrated in FIG. 14, the avatar G31 currently operated by the subsequent player is displayed. The avatar G31 is playing a soccer game with the avatar G33. Then, a virtual object G32 that performs a model action is presented. The virtual object G32 that performs a model action can also be expressed as a ghost.

Note that the space in which the model action is exemplified by the subsequent player does not necessarily coincide with the space in which the preceding player has acted. Therefore, even in a case where the spaces do not coincide with each other, a known technique of causing a ghost to perform a model action according to the space of the subsequent player may be applied. Furthermore, in a case where the action of the subsequent player in the virtual world or the real world is measured (S47), the presentation control unit 123 may cause a ghost to be presented at a timing when it is determined that the subsequent player is confused or at a timing when the subsequent player tries to move in a wrong direction on the basis of the measurement data. This can suppress an action deviating from the target.

Furthermore, the information regarding the model action may not be a ghost. For example, the information regarding the model action may be various types of information (for example, an arrow indicating a direction in which a player performing a model action moves, text information describing the model action, and the like) describing the model action.

### (S48. Target Achievement Determination)

The information acquisition unit 122 acquires an action (first action) of a subsequent player. The action of the subsequent player may include at least one of the action of the subsequent player in the real world or the action of the avatar (virtual object) operated by the subsequent player. Then, as illustrated in FIG. 12, the presentation control unit 123 determines whether or not the subsequent player has achieved the target candidate on the basis of the action of the subsequent player and the target candidate selected by the subsequent player (S48).

In a case where the presentation control unit 123 determines that the subsequent player has not achieved the target candidate (“NO” in S48), the operation proceeds to S42. On the other hand, in a case where the presentation control unit 123 determines that the subsequent player has achieved the target candidate (“YES” in S48), the presentation control unit ends the presentation of the action candidate.

The functional details of the information processing system 1 according to the embodiment of the present disclosure have been described above.

### <2. Hardware Configuration Example>

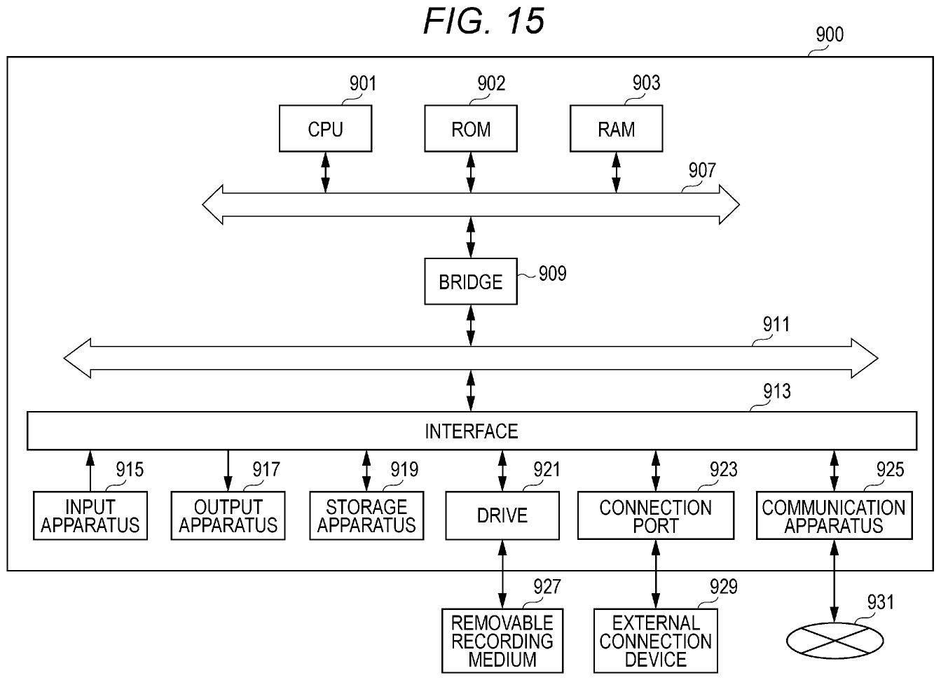

Next, a hardware configuration example of an information processing apparatus 900 as an example of the information processing apparatus 10 according to the embodiment of the present disclosure will be described with reference to FIG. 15. FIG. 15 is a block diagram illustrating the hardware configuration example of the information processing apparatus 900. Note that the information processing apparatus 10 does not necessarily have all of the hardware configurations illustrated in FIG. 15, and a part of the hardware configurations illustrated in FIG. 15 does not need to exist in the information processing apparatus 10.

As illustrated in FIG. 15, the information processing apparatus 900 includes a central processing unit (CPU) 901, a read-only memory (ROM) 903, and a random-access memory (RAM) 905. Also, the information processing apparatus 900 may include a host bus 907, a bridge 909, an external bus 911, an interface 913, an input apparatus 915, an output apparatus 917, a storage apparatus 919, a drive 921, a connection port 923, and a communication apparatus 925. The information processing apparatus 900 may have a processing circuit called a digital-signal processor (DSP) or an application-specific integrated circuit (ASIC) instead of or in combination with the CPU 901.

The CPU 901 functions as an arithmetic processing device and a control device, and controls an overall operation or a part thereof in the information processing apparatus 900, in accordance with various programs recorded in the ROM 903, the RAM 905, the storage apparatus 919, or a removable recording medium 927. The ROM 903 stores programs and calculation parameters and the like used by the CPU 901. The RAM 905 temporarily stores a program used in execution by the CPU 901, parameters that change as appropriate during the execution, and the like. The CPU 901, ROM 903, and RAM 905 are connected to each other by the host bus 907 including an internal bus such as a CPU bus. Furthermore, the host bus 907 is connected to the external bus 911 such as a peripheral component interconnect/interface (PCI) bus via the bridge 909.

The input apparatus 915 is, for example, an apparatus such as a button or the like, operated by the user. The input apparatus 915 may include a mouse, a keyboard, a touch panel, switches, and levers, and the like. Also, the input apparatus 915 may also include a microphone that detects voice of the user. The input apparatus 915 may be, for example, a remote control device utilizing infrared light or other radio waves, or may be an external connection device 929 such as a mobile phone or the like that corresponds to operation of the information processing apparatus 900. The input apparatus 915 includes an input control circuit that generates and outputs input signals to the CPU 901 on the basis of information inputted by the user. By operating the input apparatus 915, the user inputs various kinds of data or gives an instruction to perform a processing operation, to the information processing apparatus 900. Furthermore, an imaging device 933 as described later can function as an input device by capturing an image of movement of a hand of the user, a finger of the user, or the like. At this time, a pointing position may be determined according to the motion of the hand and a direction of the finger.

The output apparatus 917 is configured of an apparatus that can visually or audibly notify the user of acquired information. The output apparatus 917 may be, for example, a display apparatus such as a liquid crystal display (LCD) or an organic electro-luminescence (EL) display, or an audio output apparatus such as a speaker and headphones, and the like. Furthermore, the output apparatus 917 may include a plasma display panel (PDP), a projector, a hologram, a printer device, and the like. The output apparatus 917 outputs a result obtained by processing of the information processing apparatus 900 as a text or a video such as an image, or outputs the result as audio in the form of a voice or sound. Also, the output apparatus 917 may include a light or the like in order to brighten the surroundings.

The storage apparatus 919 is a data storage apparatus configured as an example of a storage unit of the information processing apparatus 900. The storage apparatus 919 includes, for example, a magnetic storage device such as a hard disk drive (HDD), a semiconductor storage device, an optical storage device, and a magneto-optical storage device, or the like. The storage apparatus 919 stores programs and various data executed by the CPU 901, and various data acquired from the outside, and the like.

The drive 921 is a reader/writer for the removable recording medium 927, such as a magnetic disk, an optical disk, a magneto-optical disk, or a semiconductor memory, and is built in or externally attached to the information processing apparatus 900. The drive 921 reads information recorded in the mounted removable recording medium 927, and outputs to the RAM 905. Also, the drive 921 writes records in the mounted removable recording medium 927.

A connection port 923 is a port for directly connecting a device to the information processing apparatus 900. The connection port 923 may be, for example, a universal serial bus (USB) port, an IEEE1394 port, or a small computer system interface (SCSI) port, or the like. Furthermore, the connection port 923 may be an RS-232C port, an optical audio terminal, or a high-definition multimedia interface (HDMI (registered trademark)) port, or the like. By connecting the external connection device 929 to the connection port 923, various kinds of data may be exchanged between the information processing apparatus 900 and the external connection device 929.

A communication apparatus 925 is, for example, a communication interface including a communication device for connecting to a network 931, or the like. The communication apparatus 925 can be, for example, a communication card for a wired or wireless local area network (LAN), Bluetooth (registered trademark), or wireless USB (WUSB), or the like. Also, the communication apparatus 925 may be a router for optical communication, a router for asymmetric digital subscriber line (ADSL), or a modem for various communication, or the like. The communication apparatus 925 transmits and receives, for example, signals and the like to and from the Internet and other communication devices using a predetermined protocol such as TCP/IP. Also, the network 931 connected to the communication apparatus 925 is a network connected by wire or wirelessly and is, for example, the Internet, a home LAN, infrared communication, radio wave communication, or satellite communication, or the like.

### <3. Conclusion>

According to the embodiment of the present disclosure, provided is an information processing apparatus including: a presentation control unit that controls presentation of information regarding an action target to a first user on the basis of satisfaction of a predetermined condition; and an information acquisition unit that acquires a first action of the first user after the information regarding the action target is presented. According to such a configuration, the action of the user can be more efficiently supported.

The preferred embodiment of the present disclosure has been described above in detail with reference to the accompanying drawings, but the technical scope of the present disclosure is not limited to such examples. It is obvious that those with ordinary skill in the technical field of the present disclosure may conceive various modifications or corrections within the scope of the technical idea recited in claims, and it is naturally understood that they also fall within the technical scope of the present disclosure.

Furthermore, the effects herein described are merely exemplary or illustrative, and not restrictive. That is, the technology according to the present disclosure may provide other effects described above that are apparent to those skilled in the art from the description of the present specification, in addition to or instead of the effects described above.

Note that the following configurations also fall within the technical scope of the present disclosure.
(1)
An information processing apparatus including:
a presentation control unit that controls presentation of information regarding an action target to a first user on the basis of satisfaction of a predetermined condition; and
an information acquisition unit that acquires a first action of the first user after the information regarding the action target is presented.
(2)
The information processing apparatus according to (1),
in which the presentation control unit determines whether or not the first user has achieved the action target on the basis of the first action and the action target.
(3)
The information processing apparatus according to (1) or (2),
in which the information acquisition unit acquires a second action of the first user before the information regarding the action target is presented, and
the predetermined condition includes a condition that the second action is different from a predetermined action corresponding to statistical data of one or a plurality of actions recorded in an action log database.
(4)
The information processing apparatus according to (3),
in which the statistical data is a frequency for each action in which the one or the plurality of actions recorded in the action log database is executed by one or a plurality of second user, and
the predetermined action is an action selected from the one or the plurality of actions in accordance with the frequency.
(5)
The information processing apparatus according to (4),
in which at least one of an action of the second user in a real space or an action of a virtual object operated by the second user is recorded in the action log database as the one or the plurality of actions.
(6)
The information processing apparatus according to (1) or (2),
in which the predetermined condition includes a condition that information issued from the first user is predetermined information set in advance.
(7)
The information processing apparatus according to (1) or (2),
in which the predetermined condition includes a condition that a presentation instruction of the information regarding the action target is input from the first user.
(8)
The information processing apparatus according to (1) or (2),
in which the predetermined condition includes a condition that predetermined indexes obtained within a predetermined time from one or a plurality of second users with respect to the action target are equal to or more than a predetermined number.
(9)
The information processing apparatus according to (1) or (2),
in which the presentation control unit determines, as the action target, an action in which predetermined indexes obtained from one or a plurality of second users among one or a plurality of actions recorded in an action log database are equal to or more than a predetermined number.
(10)
The information processing apparatus according to (8) or (9),
in which the predetermined indexes include at least one of a heart rate, the number of comments, or a predetermined number of words in a comment.
(11)
The information processing apparatus according to (1) or (2),
in which the information regarding the action target includes at least one of information obtained from one or a plurality of second users who has achieved the action target or information generated on the basis of an action log regarding achievement of the action target of the second user.
(12)
The information processing apparatus according to (1) or (2),
in which the presentation control unit determines the action target from one or a plurality of actions recorded in an action log database on the basis of attribute information of the first user.
(13)
The information processing apparatus according to (12),
in which attribute information is associated with each of the one or the plurality of actions, and
the presentation control unit determines, as the action target, an action associated with attribute information that matches or is similar to the attribute information of the first user among the one or the plurality of actions.
(14)
The information processing apparatus according to (12),
in which attribute information is associated with each of the one or the plurality of actions, and
the presentation control unit determines, as the action target, an action associated with attribute information having a close similarity to the attribute information of the first user among the one or the plurality of actions with priority.
(15)
The information processing apparatus according to (1) or (2),
in which the first action includes at least one of an action of the first user in a real space or an action of a virtual object operated by the first user.
(16)
The information processing apparatus according to (1) or (2),
in which in a case where the action target is selected by the first user, the presentation control unit controls presentation, to the first user, of information regarding an action candidate corresponding to a plurality of action sequences of one or a plurality of second users who has achieved the action target.
(17)
The information processing apparatus according to (16),
in which the presentation control unit maps the plurality of action sequences on a feature space having a predetermined parameter as an axis for each action sequence, assigns a label to each of a plurality of clusters generated by clustering the plurality of action sequences mapped on the feature space, and controls presentation of the label to the first user as the information regarding the action candidate.
(18)
The information processing apparatus according to (16) or (17),
in which in a case where the action candidate is selected by the first user, the presentation control unit controls presentation, to the first user, of information regarding an action corresponding to a current action of the first user among action candidates.
(19)
An information processing method including:
controlling presentation of information regarding an action target to a first user on the basis of satisfaction of a predetermined condition; and
acquiring, by a processor, a first action of the first user after the information regarding the action target is presented.
(20)
A program causing a computer to function as an information processing apparatus including:
a presentation control unit that controls presentation of information regarding an action target to a first user on the basis of satisfaction of a predetermined condition; and
an information acquisition unit that acquires a first action of the first user after the information regarding the action target is presented.

### REFERENCE SIGNS LIST

1 Information processing system
10 Information processing apparatus
120 Control unit
121 Recording control unit
122 Information acquisition unit
123 Presentation control unit
140 Storage unit
141 Detailed action log DB
142 Feedback DB
143 Abstraction action log DB
160 Communication unit
20 Interface device
210 Operation unit
220 Control unit
240 Storage unit
260 Communication unit
280 Presentation unit

1. An information processing apparatus comprising:
a presentation control unit that controls presentation of information regarding an action target to a first user on a basis of satisfaction of a predetermined condition; and
an information acquisition unit that acquires a first action of the first user after the information regarding the action target is presented.

2. The information processing apparatus according to claim 1,
wherein the presentation control unit determines whether or not the first user has achieved the action target on a basis of the first action and the action target.

3. The information processing apparatus according to claim 1,
wherein the information acquisition unit acquires a second action of the first user before the information regarding the action target is presented, and
the predetermined condition includes a condition that the second action is different from a predetermined action corresponding to statistical data of one or a plurality of actions recorded in an action log database.

4. The information processing apparatus according to claim 3,
wherein the statistical data is a frequency for each action in which the one or the plurality of actions recorded in the action log database is executed by one or a plurality of second users, and
the predetermined action is an action selected from the one or the plurality of actions in accordance with the frequency.

5. The information processing apparatus according to claim 4,
wherein at least one of an action of the second user in a real space or an action of a virtual object operated by the second user is recorded in the action log database as the one or the plurality of actions.

6. The information processing apparatus according to claim 1,
wherein the predetermined condition includes a condition that information issued from the first user is predetermined information set in advance.

7. The information processing apparatus according to claim 1,
wherein the predetermined condition includes a condition that a presentation instruction of the information regarding the action target is input from the first user.

8. The information processing apparatus according to claim 1,
wherein the predetermined condition includes a condition that predetermined indexes obtained within a predetermined time from one or a plurality of second users with respect to the action target are equal to or more than a predetermined number.

9. The information processing apparatus according to claim 1,
wherein the presentation control unit determines, as the action target, an action in which predetermined indexes obtained from one or a plurality of second users among one or a plurality of actions recorded in an action log database are equal to or more than a predetermined number.

10. The information processing apparatus according to claim 8,
wherein the predetermined indexes include at least one of a heart rate, the number of comments, or a predetermined number of words in a comment.

11. The information processing apparatus according to claim 1,
wherein the information regarding the action target includes at least one of information obtained from one or a plurality of second users who has achieved the action target or information generated on a basis of an action log regarding achievement of the action target of the second user.

12. The information processing apparatus according to claim 1,
wherein the presentation control unit determines the action target from one or a plurality of actions recorded in an action log database on a basis of attribute information of the first user.

13. The information processing apparatus according to claim 12,
wherein attribute information is associated with each of the one or the plurality of actions, and
the presentation control unit determines, as the action target, an action associated with attribute information that matches or is similar to the attribute information of the first user among the one or the plurality of actions.

14. The information processing apparatus according to claim 12,
wherein attribute information is associated with each of the one or the plurality of actions, and
the presentation control unit determines, as the action target, an action associated with attribute information having a close similarity to the attribute information of the first user among the one or the plurality of actions with priority.

15. The information processing apparatus according to claim 1,
wherein the first action includes at least one of an action of the first user in a real space or an action of a virtual object operated by the first user.

16. The information processing apparatus according to claim 1,
wherein in a case where the action target is selected by the first user, the presentation control unit controls presentation, to the first user, of information regarding an action candidate corresponding to a plurality of action sequences of one or a plurality of second users who has achieved the action target.

17. The information processing apparatus according to claim 16,
wherein the presentation control unit maps the plurality of action sequences on a feature space having a predetermined parameter as an axis for each action sequence, assigns a label to each of a plurality of clusters generated by clustering the plurality of action sequences mapped on the feature space, and controls presentation of the label to the first user as the information regarding the action candidate.

18. The information processing apparatus according to claim 16,
wherein in a case where the action candidate is selected by the first user, the presentation control unit controls presentation, to the first user, of information regarding an action corresponding to a current action of the first user among action candidates.

19. An information processing method comprising:
controlling presentation of information regarding an action target to a first user on a basis of satisfaction of a predetermined condition; and
acquiring, by a processor, a first action of the first user after the information regarding the action target is presented.

20. A program causing a computer to function as an information processing apparatus comprising:
a presentation control unit that controls presentation of information regarding an action target to a first user on a basis of satisfaction of a predetermined condition; and
an information acquisition unit that acquires a first action of the first user after the information regarding the action target is presented.
